(19) United States
(12) Patent Application Publication
(10) Pub. No.: US 2026/0051312 A1
(43) Pub. Date: Feb. 19, 2026

(54) MAGNETO-RHEOLOGICAL DEVICE FOR NOISE VIBRATION & HARSHNESS

(71) Applicant: Huawei Digital Power Technologies Co., Ltd., Shenzhen (CN)

(72) Inventors: Olivier Lobey, Munich (DE); Daniel Gaona, Munich (DE)

(73) Assignee: Huawei Digital Power Technologies Co., Ltd., Shenzhen (CN)

(21) Appl. No.: 19/270,996

(22) Filed: Jul. 16, 2025

Related U.S. Application Data
(63) Continuation of application No. PCT/EP2023/050974, filed on Jan. 17, 2023.

(51) Int. Cl. G10K 11/172; B60L 15/00; B60R 13/08; F16F 9/53; G10K 11/162

(52) U.S. Cl. CPC G10K 11/172; B60L 15/007; B60R 13/08; F16F 9/535; G10K 11/162; F16F 2222/06; F16F 2224/045; F16F 2228/066; F16F 2230/18

(57) ABSTRACT

A device for affecting noise, vibration, and harshness (NVH), for instance, reducing the NVH. The device includes a pouch, which further includes a magneto-rheological material. The pouch has a resonance frequency of vibration. The device further includes one or more coils associated with the pouch. The device is configured to activate the one or more coils associated with the pouch, which causes a property of the magneto-rheological material of the pouch to change and thereby shifts the resonance frequency of the pouch.

### CROSS-REFERENCE TO RELATED APPLICATIONS

This application is a continuation of International Application No. PCT/EP2023/050974, filed on Jan. 17, 2023, the disclosure of which is hereby incorporated by reference in its entirety.

### TECHNICAL FIELD

The embodiments relate to noise, vibrations, and harshness (NHV), for instance, in automotive application. The embodiments provide a device for affecting NVH, for instance, for reducing the NVH. The device employs a pouch including a magneto-rheological material. The embodiments also provide an assembly of at least one vehicle component and the device for affecting the NVH.

### BACKGROUND

NVH is a key market driver for automotive applications. NVH may impact the drivability and user experience. Typically, NVH is undesired in automotive applications. Thus, several approaches to reduce the negative effects of NVH have been proposed in the past decades, especially in vehicles.

For instance, some automotive suppliers add sound barriers and foams into vehicles, in order to achieve sound reduction. However, such barriers and foams, although being able to reduce the NVH by more than 3 dB for all frequencies, can be expensive and/or heavy.

Helmholtz resonators are acoustic systems including an oscillating medium plug connected to a medium volume. Helmholtz resonators can decrease NVH for frequencies corresponding to their resonance frequency (e.g., eigenfrequency). Some existing advanced solutions can change the resonance frequency of the Helmholtz resonator. However, those changes are rather limited in range and intensity, and/or require big volumes.

### SUMMARY

In view of the above, the embodiments aim for a new approach for affecting, for instance, NVH, such as by reducing NVH. An objective is to provide a device suitable to affect NVH having different and/or changing frequencies. For instance, to affect NVH that depends on one or more running conditions of an automotive application or other machine.

These and other objectives are achieved by the solutions described in the embodiments.

A first aspect of the embodiments provides a device for affecting NVH, the device including: a pouch including a magneto-rheological material, where the pouch has a resonance frequency of vibration; one or more coils associated with the pouch; where the device is configured to activate the one or more coils associated with the pouch, which causes a property of the magneto-rheological material of the pouch to change and thereby shifts the resonance frequency of the pouch.

By changing the property of the magneto-rheological material of the pouch, the properties of the pouch as a whole may change, and this may lead to the shift of the resonance frequency of the pouch. The shift of the resonance frequency of the pouch may adjust the device of the first aspect to different and/or changing frequencies of the NVH. Thus, the device can affect such NVH having different and/or changing frequencies, for instance, where the NVH depends on one or more running conditions of an automotive application or other machine.

For example, the device of the first aspect may be attached to a mechanical system, and changing the resonance frequency of the pouch may change the frequency spectrum (e.g., resonant frequencies, and/or eigenfrequencies) of the mechanical system and may thus affect NVH. The mechanical system may include one or more vehicle components, and the device may be arranged on or between one or two vehicle components.

In an implementation form of the first aspect, the device is configured to: activate the one or more coils associated with the pouch by causing a current to flow in the one or more coils; and vary a strength of the current in the one or more coils, in order to vary the property of the magneto-rheological material of the pouch and thereby to vary the shift of the resonance frequency of the pouch.

Varying the property changes of the magneto-rheological material of the pouch may also vary the property changes of the pouch itself and/or of a mechanical system, to which the pouch is attached. This may in turn change one or more resonance frequencies of the mechanical system in a variable manner and may thus efficiently affect the NVH.

In an implementation form of the first aspect, the device includes a plurality of pouches, where each pouch includes a magneto-rheological material, and where each pouch has a respective resonance frequency; and a plurality of coils, where each pouch is associated with one or more of the plurality of coils; where the device is configured to individually activate the coils, which causes the properties of the magneto-rheological material of one or more or all of the pouches to change and thereby shifts the respective resonance frequency of the one or more or all of the pouches.

In this way, the NVH can be affected even more efficiently and accurately, as the resonance frequencies of the pouches, and also the changes of their resonance frequencies, may differ and may be adjustable as needed.

In an implementation form of the first aspect, two or more of the pouches have different resonance frequencies when the coils associated with these pouches are not activated.

In an implementation form of the first aspect, two or more of the pouches have the same resonance frequency when the coils associated with these pouches are not activated.

In an implementation form of the first aspect, two or more of the pouches are arranged in parallel regarding a propagation of the NVH and/or are arranged in a same plane.

In an implementation form of the first aspect, two or more of the pouches are arranged in series regarding a propagation of the NVH and/or are arranged one upon the other.

In an implementation form of the first aspect, at least one pair of the pouches is arranged such that a first pouch of the pair surrounds a second pouch of the pair.

In an implementation form of the first aspect, the second pouch of the pair is a disk-shaped pouch and/or the first pouch of the pair is a ring-shaped pouch.

In an implementation form of the first aspect, for at least one pouch, the one or more coils associated with that pouch are arranged on the pouch.

In an implementation form of the first aspect, for at least one pouch, the one or more coils associated with that pouch are arranged around the pouch.

In an implementation form of the first aspect, for at least one pouch, the one or more coils associated with that pouch are arranged at least partly within the pouch.

In an implementation form of the first aspect, each pouch is configured to act as a Helmholtz resonator that has the respective resonance frequency.

In an implementation form of the first aspect, the device further includes: one or more NVH receptors configured to detect one or more frequencies of the NVH; and a controller configured to activate one or more coils associated with at least one pouch according to the detected one or more frequencies of the NVH.

Thus, the at least one pouch can be more accurately adjusted based on the actual NVH, as it is picked up by the one or more NVH receptors.

In an implementation form of the first aspect, the one or more NVH receptors include at least one of a microphone, an accelerometer, a laser, a force gauge, a load cell, strain gauge, and a camera.

A second aspect of the embodiments provides an assembly of at least one vehicle component and a device according to the first aspect or any of its implementation forms, where the device is arranged on the at least one vehicle component susceptible to NVH and/or is arranged between two vehicle components susceptible to NVH.

The device enables affecting the NVH in said vehicle component(s), for instance, reducing the NVH.

In an implementation form of the second aspect, the assembly has an assembly resonance frequency, and where the activation of one or more coils associated with one or more pouches of the device causes the assembly resonance frequency to shift.

In an implementation form of the second aspect, the device is arranged between an electronic motor and an inverter and/or is arranged on the inverter.

In an implementation form of the second aspect, the device is arranged on an NVH emitting surface and/or on a powertrain packaging and/or on a vehicle compartment dashboard.

A third aspect of the embodiments provide a method of operating a device for affecting NVH. The device includes a pouch including a magneto-rheological material, the pouch having a resonance frequency of vibration; where the device includes one or more coils associated with the pouch; and where the method includes: activating the one or more coils associated with the pouch, which causes a property of the magneto-rheological material of the pouch to change and thereby shifts the resonance frequency of the pouch.

The method of the third aspect may have implementation forms according to the implementation forms of the device of the first aspect. For instance, the device operated by the method of the third aspect may be the device of the first aspect or any of its implementation forms. For instance, the method may include a step of detecting, with the one or more NVH receptors of the device, one or more frequencies of the NVH, and may also include a step of activating, with the controller of the device, one or more coils associated with at least one pouch according to the detected one or more frequencies of the NVH.

The method may also be suitable to operate the assembly of the second aspect.

A fourth aspect of the embodiments provides a computer program including instructions which, when the program is executed by a processor, cause the processor to perform the method according to the third aspect, or cause the device of the first aspect or any implementation form thereof, such as the controller of the device, to activate one or more coils associated with at least one pouch.

A fifth aspect of the embodiments provides a non-transitory (computer-readable) storage medium storing executable program code which, when executed by a processor, causes the method according to the third aspect to be performed.

The embodiments, according to the above aspects and implementation forms, introduces a novel device and method for affecting NVH, for instance, for achieving NVH reduction. Notably, the device and method are also able to increase the NVH, if this is desired. For instance, to increase the NVH produced by an electric vehicle, for example, to mimic a non-electronic vehicle. Although the solutions of the embodiments may be utilized in the automotive sector, applications of these solutions in other sectors where NVH appears or plays a role, are also possible.

The device of the embodiments may include one or several pouches of magneto-rheological material, which may be combined respectively with one or more coils. Each pouch may act as a Helmholtz resonator, and may change the noise transmission for each frequency of NVH, depending on its shape and Young modulus. Each coil, when activated, may change the Young modulus of the magneto-rheological material of the paired pouch, thus changing the resonance frequency of the pouch. A pouch, when combined with other pouches, may absorb different frequencies or different ranges of frequencies.

The device may be inserted into at least one of the three noise path steps of NVH (i.e., N, V, and/or H) and may affect N, V, and/or H. The device may also include the NVH receptor, which may be added or may already be integrated into the pouch architecture. The controller may be configured to manage the resonance frequency and/or eigenfrequency matrix of one or more pouches.

The proposed device can be applied to mechanical systems subjected to vibrations or mechanical resonances. In a vehicle, for instance, this mechanical system can be located in critical part of the powertrain.

It is noted that some devices, elements, units, manners, and means described herein could be implemented in the software or hardware elements or any kind of combination thereof. Some steps which are performed by the various entities described in the embodiments as well as the functionalities described to be performed by the various entities are intended to mean that the respective entity is adapted to or configured to perform the respective steps and functionalities. Further, if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF DRAWINGS

The above described aspects and implementation forms will be explained in the following description of specific embodiments in relation to the enclosed drawings, in which

FIG. 1 shows a device according to the embodiments, which includes one pouch.

FIG. 2 shows respective devices according to the embodiments, which include multiple pouches.

FIG. 3 shows respective devices according to the embodiments, which include a pair of pouches.

FIG. 4 shows a device according to the embodiments, which includes an NVH receptor and a controller.

FIG. 5 shows a device according to the embodiments, which includes a pouch with a coil on top of the pouch.

FIG. 6 shows a device according to the embodiments, which includes a pouch with a coil on the side of or surrounding the pouch.

FIG. 7 shows a device according to the embodiments, which includes a pouch with a coil embedded in the pouch.

FIG. 8 shows an assembly according to the embodiments, which includes an inverter, a motor, and a device.

FIG. 9 shows an assembly according to the embodiments, which includes an inverter, a motor, and several devices

FIG. 10 shows a method for affecting NVH according to the embodiments.

### DETAILED DESCRIPTION OF EMBODIMENTS

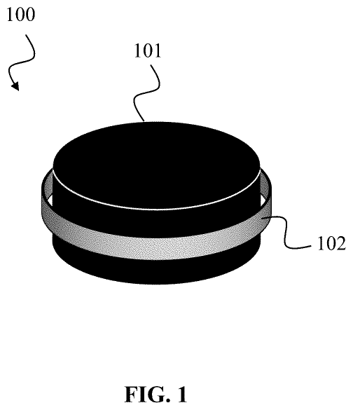

FIG. 1 shows a device 100 according to the embodiments. The device 100 is configured to affect noise, vibration, and harshness (NVH), including, N, V, and/or H. For instance, the device 100 may be configured to reduce or suppress the NVH. The device 100 may, however, also be configured to increase or enhance the NVH. The device 100 may be adjustable to either reduce or increase the NVH, as desired. The device 100 may be used in an automotive application, for example, may be installed on or near a motor of a vehicle. However, the device 100 may also be used for other applications where NVH is an issue.

The device 100 includes a pouch 101, which includes a magneto-rheological material. The pouch 101 may be made of the magneto-rheological material or may be filled with the magneto-rheological material. In the latter case, the pouch may include an envelope material, for instance, a plastic, which surrounds and holds the magneto-rheological material.

A magneto-rheological material is generally a material whose rheological properties may be changed by application of a magnetic field. For instance, a magneto-rheological material may include magnetic (e.g., ferrous) particles (e.g., of micrometer size), which are dispersed in an elastomer, a gel, or a fluid.

In an example, the magneto-rheological material of a pouch 101 may be in the form of a gel. The magneto-rheological gel may include carbonyl iron or other magnetic particles. A magnetic field generated by at least one coil 102 may change the orientation and alignment of the magnetic particles in the magneto-rheological gel, which may change the rheological properties of the magneto-rheological gel, for instance, its Young's modulus. For instance, without a magnetic field, the magneto-rheological gel may have a different elasticity or stiffness or Shear modulus than with a magnetic field that is above a first threshold. For instance, the first threshold may be around 100 mT of flux density, and above that a Shear modulus of the magneto-rheological gel may change linearly until reaching a second (saturation) threshold of, for instance, 800 mT.

In another example, the magneto-rheological material of a pouch 101 may be a magneto-rheological fluid, for instance, a type of oil. Magnetic particles may be suspended within the carrier oil and may be distributed randomly in suspension under normal circumstances. When a magnetic field is applied with at least one coil 102, the magnetic particles may align themselves along the lines of magnetic flux. In this way, the magnetic field may increase the viscosity of the magneto-rheological fluid, for example, to the point of becoming a viscoelastic solid. The magneto-rheological fluid may be defined by a Shear modulus, which gives a measure of stiffness of a material. The Young's modulus may describe a strain response to uniaxial stress in the direction of this stress of a material. For instance, increasing the Shear modulus of the magneto-rheological fluid by 10% as a cause of the applied magnetic field, may increase the Young's modulus by 10% as well.

In another example, the magneto-rheological material of a pouch 101 may also be a magneto-rheological elastomer, which may be more stable than a magneto-rheological fluid over time. In such a magneto-rheological elastomer, a magnetic particle aggregation structure change may be more limited, if a magnetic field is applied with at least one coil 102. Only a small rotation and deviation of the magnetic particles may be caused by the magnetic field

However, in a specific example, the Shear modulus of the magneto-rheological elastomer can be increased by more than 400% from 100 mT to 800 mT of flux density.

The pouch 101 has a resonance frequency of vibration, which may be determined by its size, shape, and/or the type of the magneto-rheological material. For example, the type of magnetic particles and type of magnetic gel or fluid including these magnetic particles may impact the resonance frequency.

The device 100 further includes one or more coils 102, which are associated with the pouch 101. As an example, FIG. 1 shows one coil 102 that surrounds the pouch 101. The device 100 is configured to activate the coil 102 associated with the pouch 101, for instance, by causing a current to flow in the coil 102. This may be done by a controller of the device 100. The activation of the coil 102 may cause a magnetic field to be generated. The activation of the coil 102 causes a property of the magneto-rheological material of the pouch 101 to change, for instance, a Young's modulus thereof to change. For instance, a magnetic field generated by the coil 102 may change the magnetic orientation of the magnetic particles in a magneto-rheological gel or fluid, and may thus change a mechanical property, like a stiffness or elasticity, of the pouch 101. The activation of the coil 102 shifts the resonance frequency of the pouch 101. In this way, the resonance frequency of the pouch 101 can be adjusted for different and/or changing frequencies of the NVH.

The device 100, such as the controller of the device 100, may also vary a strength of the current in the coil 102, in order to vary the property changes of the magneto-rheological material of the pouch 101. For instance, by thereby varying a strength and/or orientation of a magnetic field generated by the activation of the coil 102. This may vary the shift of the resonance frequency of the pouch 101. The resonance frequency of the pouch 101 may thus be tunable over a certain frequency range.

Generally, the device 100 may include one or several pouches 101, each of a magneto-rheological material, where each pouch 101 is also associated with and/or combined with at least one coil 102. Each pouch 101 may include the same of magneto-rheological material, but at least two or more pouches 101 may also differ in their magneto-rheological material. Each pouch 101 may have a respective resonance frequency. Two or more of the pouches 101 may have the same resonance frequency, and/or two or more of the pouches 101 may have different resonance frequencies. Each pouch 101 may act as a Helmholtz resonator, able to change noise transmission for one or more frequencies, for instance, depending on its shape and Young's modulus. Each coil 102, when activated, may change the Young's modulus of the pouch 101 it is associated with, and may thus change the eigenfrequency of the pouch 101. The device 100, such as the controller of the device 100, may be configured to activate one or more or all coils 102 of the device 100, in order to shift the respective resonance frequency of one or more or all of the pouches 101 of the device 100.

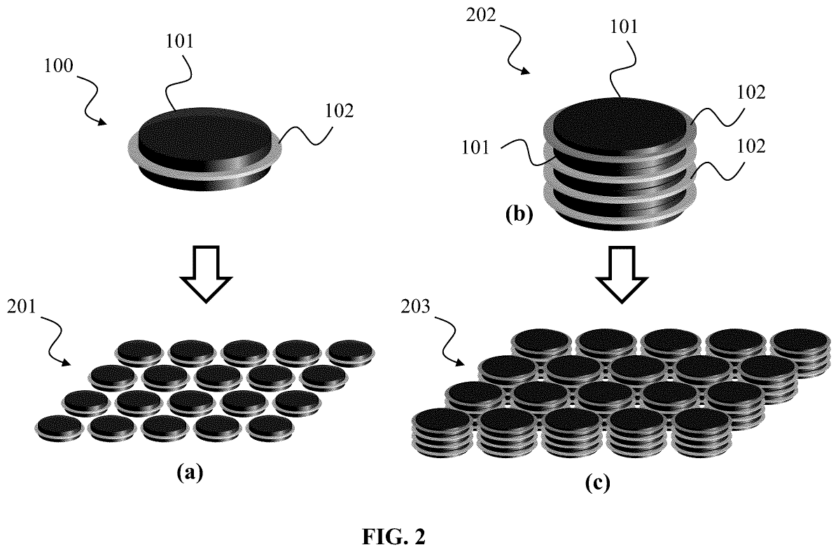

FIG. 2 shows exemplary devices 201, 202, and 203 according to the embodiments, respectively, in (a), (b) and (c). The devices 201, 202, and 203 may develop the device 100 shown in FIG. 1, and each include multiple pouches 101, as seen in the respective figures. Each device 201, 202 and 203 includes a plurality of pouches 101, where each pouch 101 includes a magneto-rheological material, and where each pouch 101 has a respective resonance frequency

As shown in FIG. 2(a) for the device 201, several individual pouches 101 may be arranged in parallel, for instance, they may be arranged in parallel with respect to a propagation of the NVH. The pouches 101 may also be arranged in the same plane as illustrated. The pouches 101 may form an array of pouches, for instance, a planar array. The pouches 101 may be arranged in one or two dimensions in the plane. Each pouch 101 may be designed like the pouch 101 of FIG. 1, that is, it may include a coil 102 arranged around the pouch 101.

As shown in FIG. 2(b) for the device 202, multiple pouches 101 may be arranged in series, for instance, they may be arranged in series with respect to a propagation of the NVH. The pouches 101 may be arranged one upon the other as shown. The pouches 101 arranged on top of each other may form a pouch stack. Each pouch 101 may thereby be designed like the pouch 101 of FIG. 1, that is, it may include a coil 102 arranged around the pouch 101. However, it may also be possible to arrange one or more coils 102 around the entire pouch stack, or to associate the one or more coils 102 in a different manner with each pouch 101 of the pouch stack.

As shown in FIG. 2(c) for the device 203, it is also possible to arrange several pouch stacks (as shown in FIG. 2(b)) in parallel, for example, with respect to a propagation of the NVH. The multiple pouch stacks may also be arranged in a same plane as shown. For instance, the pouch stacks may form an array of pouch stacks, for instance, a planar array. The pouch stacks may be arranged in one or two dimensions in the plane.

Moreover, a device of the embodiments could also include multiple pouches 101, which are arranged both in parallel and in series. In all arrangements derivable from FIG. 2, two or more of the pouches 101 may have the same resonance frequency, when their associated one or more coils 102 are not activated, and/or two or more of the pouches 101 may have different resonance frequencies, when their associated one or more coils 102 are not activated.

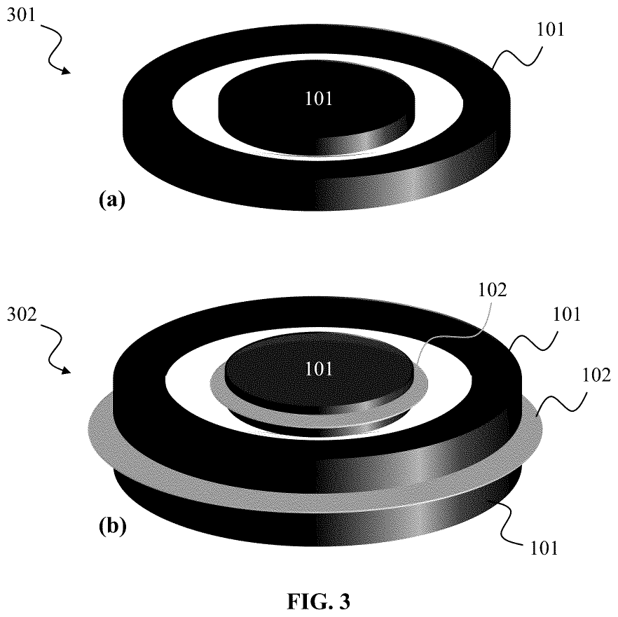

FIG. 3 shows exemplary devices 301 and 302 according to the embodiments, respectively, in (a) and (b). The devices 301 and 302 may develop the device 100 shown in FIG. 1, and both include a pair of pouches 101. That is, the devices 301 and 302 each include at least two pouches 101, and these two pouches 101 form the pair. Each pouch 101 again includes a magneto-rheological material, and each pouch 101 again has a respective resonance frequency.

As shown in FIG. 3(a) for the device 301, a first pouch 101 of the pair may surround a second pouch 101 of the pair. The second pouch 101 of the pair may be a disk-shaped pouch, and the first pouch 101 of the pair may be a ring-shaped pouch. One or more coils 102 may be arranged around the pair of pouches 101 as a whole, and/or may be associated with both pouches 101 of the pair.

As shown in FIG. 3(b) for the device 302, one or more coils 102 may also be associated with each pouch 101 of the pair, for instance arranged around the pouch 101 as illustrated. The inner pouch 101 is smaller than the outer pouch 101, and accordingly also the inner coil 102 may be smaller in diameter than the outer coil 102.

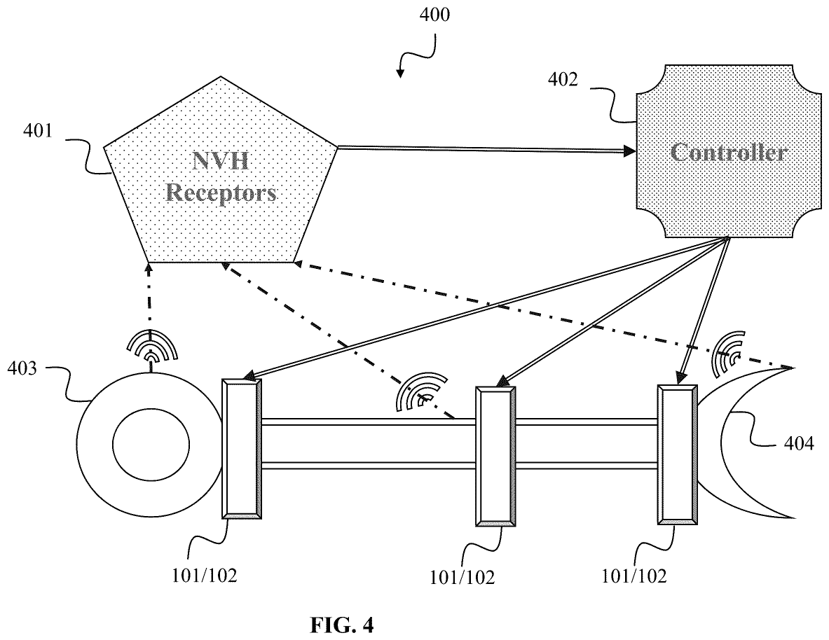

FIG. 4 shows an exemplary device 400 according to the embodiments, which may build on any one of the devices 100, 201, 202, 203, 301, and 302 shown in the FIGS. 1-3. The device 400 of FIG. 4 may include one or more pouches 101, each pouch 101 being associated with one or more coils 102, or one or more pouch stacks as described above. Exemplarily, three pouches or pouch stacks are shown in FIG. 4 (labelled 101/102).

The device 400 further includes one or more NVH receptors 401, only as an example one such NVH receptor 401 is shown in FIG. 4. Each NVH receptor 401 is configured to detect one or more frequencies of NVH, for instance, in a vehicle. Further, the device 400 includes a controller 402, which is configured to activate one or more of the coils 102 associated with the pouches 101 of pouch stacks. The controller 402 is thus configured to activate the coils 102 of selected pouches 101 of pouch stacks, especially according to the detected one or more frequencies of the NVH. Each selected pouch 101 of pouch stack may be adjusted to a different resonance frequency. The one or more coils 102 of the selected pouches 101 or pouch stacks may be respectively activated based on different current strengths to produced different magnetic fields.

Each of the one or more NVH receptors 401 may include at least one of a microphone, an accelerometer, a laser, a force gauge, a load cell, a strain gauge, and a camera. The controller may be a computer or micro-controller or the like.

The controller 402 may include a processor or processing circuitry (not shown) configured to perform, conduct or initiate the various operations of the controller 402 described herein. The processing circuitry may include hardware and/or the processing circuitry may be controlled by software. The hardware may include analog circuitry or digital circuitry, or both analog and digital circuitry. The digital circuitry may include components such as application-specific integrated circuits (ASICs), field-programmable arrays (FPGAs), digital signal processors (DSPs), or multi-purpose processors. The controller 402 may further include memory circuitry, which stores one or more instruction(s) that can be executed by the processor or by the processing circuitry, such as under control of the software. For instance, the memory circuitry may include a non-transitory storage medium, such as a non-transitory computer-readable storage medium, storing executable software code which, when executed by the processor or the processing circuitry, causes the various operations of the controller 402 to be performed. In one embodiment, the processing circuitry includes one or more processors and a non-transitory memory connected to the one or more processors. The non-transitory memory may carry executable program code which, when executed by the one or more processors, causes the controller 402 to perform, conduct or initiate the operations or methods described herein. The memory may include instructions which, when executed by a processor, cause the processor to cause the controller 402 to activate one or more coils 102 associated with at least one pouch 101.

The device 400 may further include a source 403 of the NVH, which may produce the NVH when operated. For instance, the source 403 may be a motor. To affect this NVH, the controller 402 can cause a power source to provide the current through the coils 102 to activate the coils 102. The power source may be a power source of the controller 402 and may be embedded with the controller 402. The power source may also be connected to and controlled by the controller.

The device 400 may further include a loudspeaker 404, for instance, to produce sound based on the NVH affected by the pouches 101 or pouch stacks.

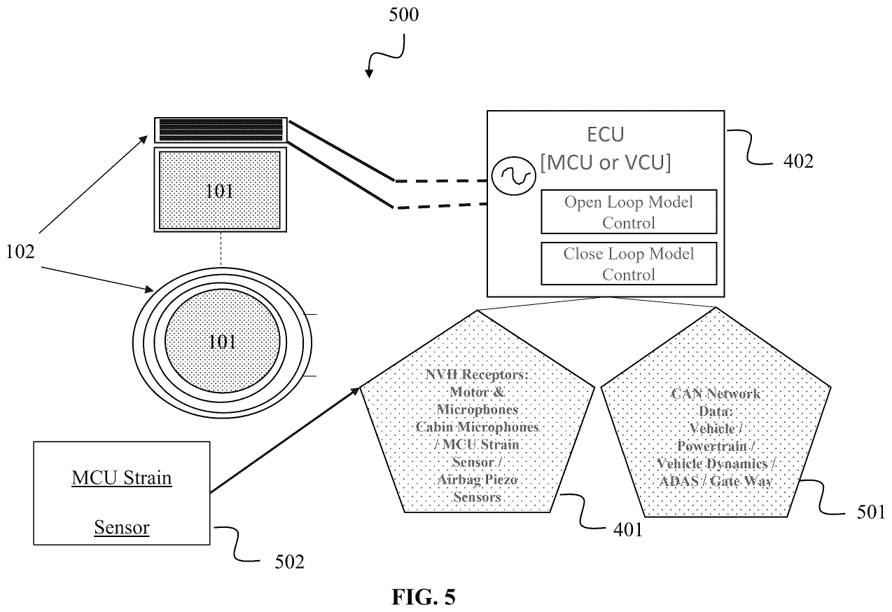

FIG. 5 shows schematically a device 500 according to the embodiments. The device 500 includes at least one pouch 101 and at least one coil 102 associated with the pouch 101. The coil 102 is shown arranged on the pouch 101. In an embodiment, for at least one pouch 101 of the device 500, the one or more coils 102 associated with that pouch 101 are arranged on the pouch 101.

The device 500 further includes an NVH receptor 401, which exemplarily includes a microcontroller unit (MCU) strain sensor 502. However, the NVH receptor 401 may also include one or more microphones (motor or cabin of a vehicle), an airbag sensor of a vehicle, or the like. The controller 402 of the device 500 may be an electronic control unit (ECU), for example, of a vehicle, that is, a vehicle control unit (VCU). The controller 402 may be connected to the NVH receptor 401 and may be optionally connected to a controller area network (CAN). The controller 402 may be configured to receive data, for example, vehicle data, powertrain data, vehicle dynamics data, advanced driver-assistance system (ADAS) data, and/or data from a gate way. The controller 402 may be configured to operate in an open loop model and/or in a closed loop model, for controlling the one or more coils 102 according to the detected one or more frequencies of the NVH received from the NVH receptor 401.

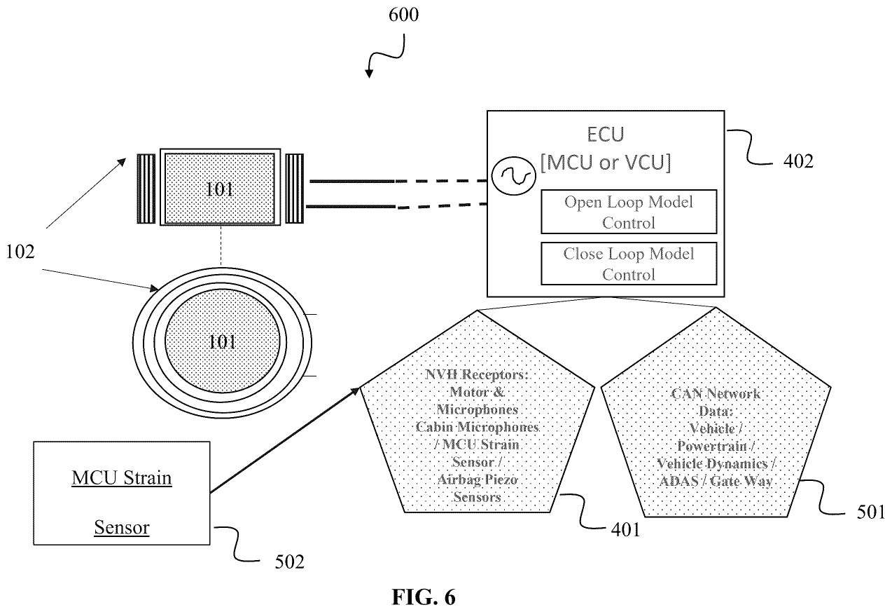

FIG. 6 shows schematically a device 600 according to the embodiments. The device 600 includes at least one pouch 101 and at least one coil 102 associated with the pouch 101. The device 600 is similar to the device 500 of FIG. 5, however, for at least one pouch 101 of the device 600 of FIG. 6, the one or more coils 102 associated with that pouch 101 are arranged around the pouch 101 or on a side of the pouch 101.

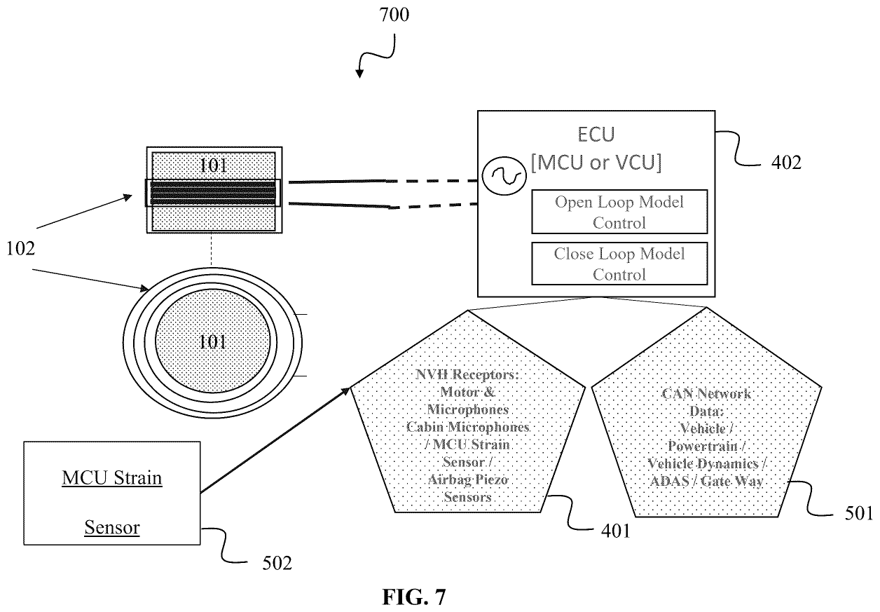

FIG. 7 shows schematically a device 700 according to the embodiments. The device 700 includes at least one pouch 101 and at least one coil 102 associated with the pouch 101. The device 700 is similar to the device 500 of FIG. 5, however, for at least one pouch 101 of the device 700 of FIG. 7, the one or more coils 102 associated with that pouch 101 are arranged at least partly within the pouch 101 and/or are embedded within the pouch 101.

The arrangements of the coils 102 with regard to the respectively associated pouches 101 in the FIGS. 5-7 may be combined. That is, a device of the embodiments may also include at least two of the following: a pouch 101 whose associated one or more coils 102 are arranged around or besides the pouch 101; a pouch 101 whose associated one or more coils 102 are arranged on top of or beneath the pouch 101; a pouch 101 whose associated one or more coils 102 are arranged partly within or embedded in the pouch 101.

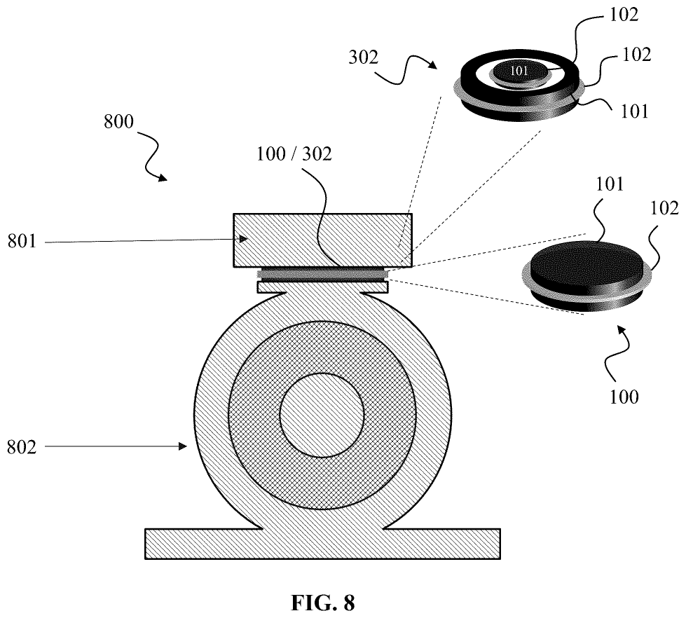

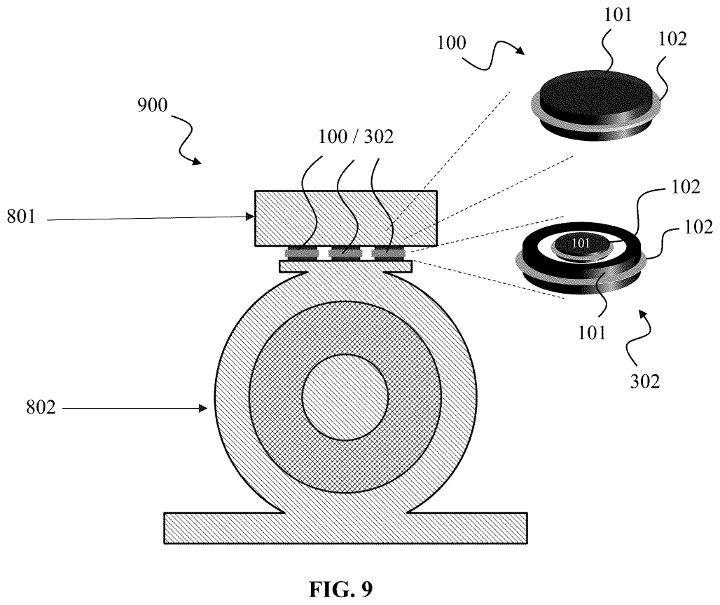

FIG. 8 shows an exemplary assembly 800 according to the embodiments. The assembly 800 of FIG. 8 includes a device according to any one of the previous figures, where the device is arranged between two vehicle components 801, 802 that are susceptible to NVH, the vehicle components 801, 802 being part of the assembly. For example, the device of FIG. 9 is inserted between an electric motor 802 and an inverter 801 being two vehicle components of the assembly. The device is also arranged on the inverter 801. The device may be designed as the device 100 or 302 described with respect to FIG. 1 or FIG. 3(b), as illustrated in FIG. 8.

The assembly 800 of the electric motor 802, the inverter 801, and the device may have (as a whole) an assembly resonance frequency. The activation of one or more coils 102 associated with the pouch(es) 101 of the device can cause the assembly resonance frequency to shift.

FIG. 9 shows an exemplary assembly 900 according to the embodiments. The assembly 900 of FIG. 9 is similar to that of FIG. 8. However, in FIG. 9, multiple devices (according to any of the previous figures) are inserted between the electronic motor 802 and the inverter 801. The multiple devices could each be designed as the device 100 or 302 described with respect to FIG. 1 or FIG. 3(b), as illustrated in FIG. 9.

In another example of an assembly of the embodiments, one or more devices according to the embodiments could be provided on top of any surface emitting NVH (e.g., of a vehicle), such as on a powertrain packaging, or on a vehicle compartment dashboard.

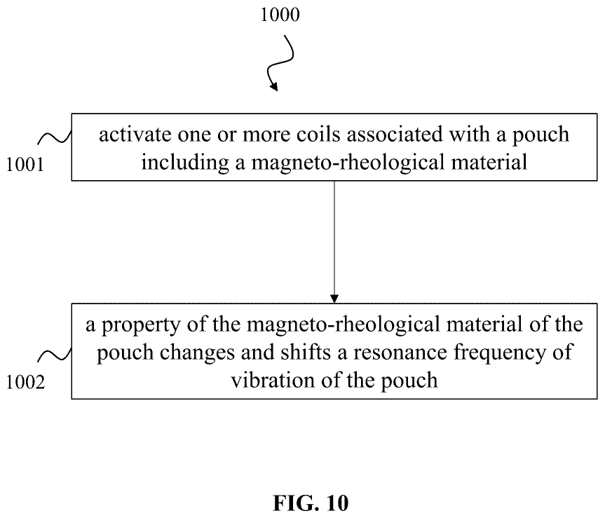

FIG. 10 shows a method 1000 according to the embodiments. The method 1000 is for operating a device 100 for affecting NVH, for instance, a device 100 as described above with respect to the previous figures. The device 100 includes a pouch 101 including a magneto-rheological material, where the pouch 101 has a resonance frequency of vibration, as explained before. The device 100 also includes one or more coils 102 associated with the pouch 101. The method 1000 includes a step 1001 of activating the one or more coils 102 associated with the pouch 101. For instance, the controller 402 of the device may be used to activate a current source 403 to flow a current through the one or more coils 102. This leads to a property of the magneto-rheological material of the pouch 101 to change and thereby results in a step 1002 of shifting the resonance frequency of the pouch 101. The method 100 may also be used for operating any one of the devices 201, 202, 203, 301, 302, 400, 500, 600, and 700 shown in the FIGS. 2-7.

The embodiments have been described in conjunction with various embodiments as examples as well as implementations. However, other variations can be understood and effected by those persons skilled in the art. In the descriptions, the words “including” and “comprising” does not exclude other elements or steps and the indefinite article “a” or “an” does not exclude a plurality. A single element or other unit may fulfill the functions of several entities or items. The mere fact that certain measures are recited in the mutual different embodiments does not indicate that a combination of these measures cannot be used in an advantageous implementation, and any such implementations should be within the scope of the embodiments herein.

1. A device for affecting noise, vibration, and/or harshness, NVH, the device comprising:
a pouch including a magneto-rheological material, wherein the pouch has a resonance frequency of vibration; and
one or more coils associated with the pouch;
wherein the device is configured to activate the one or more coils associated with the pouch, which causes a property of the magneto-rheological material of the pouch to change and thereby shifts the resonance frequency of the pouch.

2. The device according to claim 1, wherein the device is further configured to:
activate the one or more coils associated with the pouch by causing a current to flow in the one or more coils; and
vary a strength of the current in the one or more coils in order to vary the property of the magneto-rheological material of the pouch and to vary the shift of the resonance frequency of the pouch.

3. The device according to claim 1, further comprising:
a plurality of pouches, wherein each pouch includes a magneto-rheological material, and wherein each pouch has a respective resonance frequency; and
a plurality of coils, wherein each pouch is associated with one or more of the plurality of coils;
wherein the device is further configured to individually activate the coils, which causes the properties of the magneto-rheological material of one or more or all of the pouches to change and thereby shifts the respective resonance frequency of the one or more or all of the pouches.

4. The device according to claim 3, wherein two or more of the pouches have different resonance frequencies when the coils associated with these pouches are not activated.

5. The device according to claim 3, wherein two or more of the pouches have the same resonance frequency when the coils associated with these pouches are not activated.

6. The device according to claim 3, wherein two or more of the pouches are arranged in parallel regarding a propagation of the NVH and/or are arranged in a same plane.

7. The device according to claim 3, wherein two or more of the pouches are arranged in series regarding a propagation of the NVH and/or are arranged one upon the other.

8. The device according to claim 3, wherein at least one pair of the pouches is arranged such that a first pouch of the pair surrounds a second pouch of the pair.

9. The device according to claim 8, wherein the second pouch of the pair is a disk-shaped pouch and/or the first pouch of the pair is a ring-shaped pouch.

10. The device according to claim 1, wherein, for at least one pouch, the one or more coils associated with that pouch are arranged on the pouch.

11. The device according to claim 1, wherein, for at least one pouch, the one or more coils associated with that pouch are arranged around the pouch.

12. The device according to claim 1, wherein, for at least one pouch, the one or more coils associated with that pouch are arranged at least partly within the pouch.

13. The device according to claim 1, wherein each pouch is configured to act as a Helmholtz resonator that has the respective resonance frequency.

14. The device according to claim 1, further comprising:
one or more NVH receptors configured to detect one or more frequencies of the NVH; and
a controller configured to activate one or more coils associated with at least one pouch according to the detected one or more frequencies of the NVH.

15. The device according to claim 14, wherein the one or more NVH receptors comprise at least one of a microphone, an accelerometer, a laser, a force gauge, a strain gauge, a load cell, strain gauge, and a camera.

16. A system comprising at least one vehicle component and a device (100, 302), wherein the device is arranged on the at least one vehicle component and that at least one vehicle component is susceptible to NVH and/or is arranged between two vehicle components susceptible to NVH;
the device comprising a pouch including a magneto-rheological material, wherein the pouch has a resonance frequency of vibration; and
one or more coils associated with the pouch;
wherein the device is configured to activate the one or more coils associated with the pouch, which causes a property of the magneto-rheological material of the pouch to change and thereby shifts the resonance frequency of the pouch.

17. The system according to claim 16, wherein the at least one vehicle component and the device have an assembly resonance frequency, and wherein the activation of one or more coils associated with one or more pouches of the device causes the assembly resonance frequency to shift.

18. The system according to claim 16, wherein the device is arranged between an electronic motor and an inverter and/or is arranged on the inverter.

19. The system according to claim 16, wherein the device is arranged on an NVH emitting surface and/or on a powertrain packaging and/or on a vehicle compartment dashboard.

20. A method of operating a device for affecting noise, vibration, and/or harshness (NVH),
wherein the device comprises a pouch including a magneto-rheological material, the pouch having a resonance frequency of vibration,
and one or more coils associated with the pouch; and
the method comprises:
activating the one or more coils associated with the pouch, which causes a property of the magneto-rheological material of the pouch to change and thereby shifts the resonance frequency of the pouch.
